(19) United States
(12) Patent Application Publication
(10) Pub. No.: US 2026/0249578 A1
(43) Pub. Date: Aug. 27, 2026

(54) PISTON COMPACTOR

(71) Applicant: Kongskilde Industries A/S, Sorø (DK)

(72) Inventor: Asger Kildevang Knudsen, Sorø (DK)

(21) Appl. No.: 18/992,041

(22) PCT Filed: Jul. 7, 2023
(86) PCT No.: PCT/EP2023/068810

§ 371 Date: Jan. 7, 2025

(30) Foreign Application Priority Data
Jul. 8, 2022 (DK) PA202270368

(51) Int. Cl. B30B 15/30; B30B 9/06

(52) U.S. Cl. CPC B30B 15/30; B30B 9/06

(57) ABSTRACT

A piston compactor adapted for compacting e.g. waste material and comprising a compactor tube (1) with a compactor piston (4) and a drive mechanism (5) arranged at one end and being adapted for repetitively moving the piston between a retracted and an extended position in the compactor tube, and where the piston compactor comprises a feeding pipe (9) with pipe walls (10) and an outlet end (11) being connected to a feed opening (12) arranged in the tube wall between the retracted and the extended position. The piston compactor further comprises a first suction conduit (13) having a first end (14) that is connected to the feeding pipe via a first suction opening (15) arranged near the feed opening and a second end (17) that is connected to a suction source (16), and that a suction control (18) is adapted for applying suction to the feeding pipe via the first end of the first suction conduit at least when the compactor piston is in its extended position and to shut off the suction at the first end of the first suction conduit at least when the compactor piston is in its retracted position.

### PRIOR ART

The present invention relates to the field of compacting or separating material using a piston compactor comprising a compactor tube with a tube wall extending along a longitudinal axis and where a compactor piston and a drive mechanism is arranged at one end of the compactor tube and being adapted for repetitively moving the piston along the longitudinal axis between a retracted and an extended position in the compactor tube, and where the piston compactor comprises a feeding pipe with pipe walls and an outlet end being connected to a feed opening arranged in the tube wall between the retracted and the extended position.

Piston compactors of this type are often used in pneumatic transport systems where many different types of material, e.g. waste material is forced through a pipe system by flowing air through the pipes using e. g a blower.

An example of such a piston compactor is known from U.S. Pat. No. 3,948,167.

### OBJECT OF THE INVENTION

On this background it is the purpose of the present invention to provide a piston compactor of the above mentioned type and that provides an efficient and continuous flow of air, and thereby transportation of material though the pipe system during the whole compaction cycle.

This is obtained by a piston compactor as specified in present claim 1 further specifying that the piston compactor further comprises a first suction conduit having a first end that is connected to the feeding pipe via a first suction opening arranged near, and in connection with, the feed opening and a second end that is connected to a suction source, and that a suction control is adapted for applying suction to the feeding pipe via the first end of the first suction conduit at least when the compactor piston is in its extended position and to shut off the suction at the first end of the first suction tube at least when the compactor piston is in its retracted position.

In a preferred embodiment a suitable grid is arranged in the first suction opening in order to prohibit that material from the feeding pipe is sucked into the first suction conduit.

In a further preferred embodiment the piston compactor further comprises a second suction conduit having a first end that is connected to the tube wall of the compactor tube and a second end that is connected to a suction source, and that a suction control is adapted for applying suction to the compactor tube via the first end of the second suction conduit at least when the compactor piston is in its retracted position and to shut off the suction at the first end of the second suction tube at least when the compactor piston is in its extended position. Thereby the flow of air through the feeding pipe can be even more constant during the whole compaction cycle.

In this relation a grid may advantageously be arranged in the second suction opening in order to prohibit that material is sucked into the second suction conduit from the compactor tube.

The suction source may comprise a blower adapted to provide suction to the second end of both the first and the second suction conduit.

The blower may advantageously be connected to the second end of both the first and the second suction conduit via a valve arrangement, e.g. a Y-valve, adapted for shifting the suction applied from the blower between the first and the second suction conduit.

A single actuator or motor may advantageously be used for actuating both the valve arrangement and the compactor piston via a gear or a link mechanism.

In order to ensure efficient suction through the system the compactor tube may preferably comprise a second end and a constriction arranged between the second end and the compactor piston in its extended position, and in this relation the constriction may preferably comprise a control mechanism adapted for manual or automatic adjustment of the level of the size of the constriction.

In a preferred embodiment the piston compactor comprises a housing containing the suction source, the compactor piston and its drive mechanism as well as the suction conduits, and furthermore that an outlet end of the compactor tube and an inlet end of the feed pipe opposite the outlet end both extend from the inside and out of the housing.

### THE DRAWING

FIG. 1: Is a cross section drawing showing a detail of a piston compactor as shown in FIG. 5 in a first position.

FIG. 2: Is a cross section drawing showing a detail of a piston compactor as shown in FIG. 5 in a second position.

FIG. 3: Is a cross section drawing showing a detail of a piston compactor as shown in FIG. 5 in a third position.

FIG. 4: Is a cross section drawing showing a detail of a piston compactor as shown in FIG. 5 in a fourth position.

FIG. 5. Is a view of one embodiment of a piston compactor according to the invention.

FIG. 6: Is a view of the piston compactor as shown in FIG. 5 with a casing.

### DESCRIPTION OF AN EMBODIMENT:

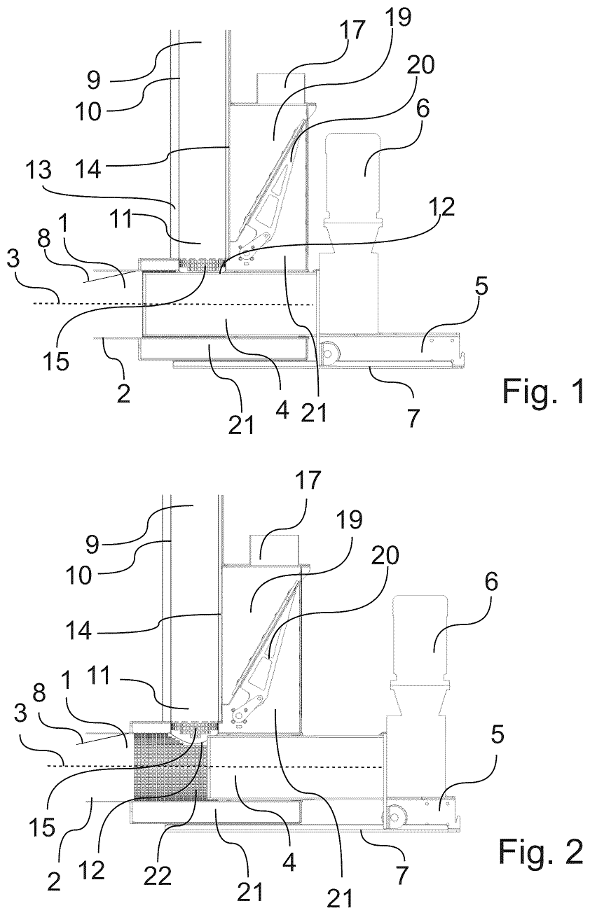

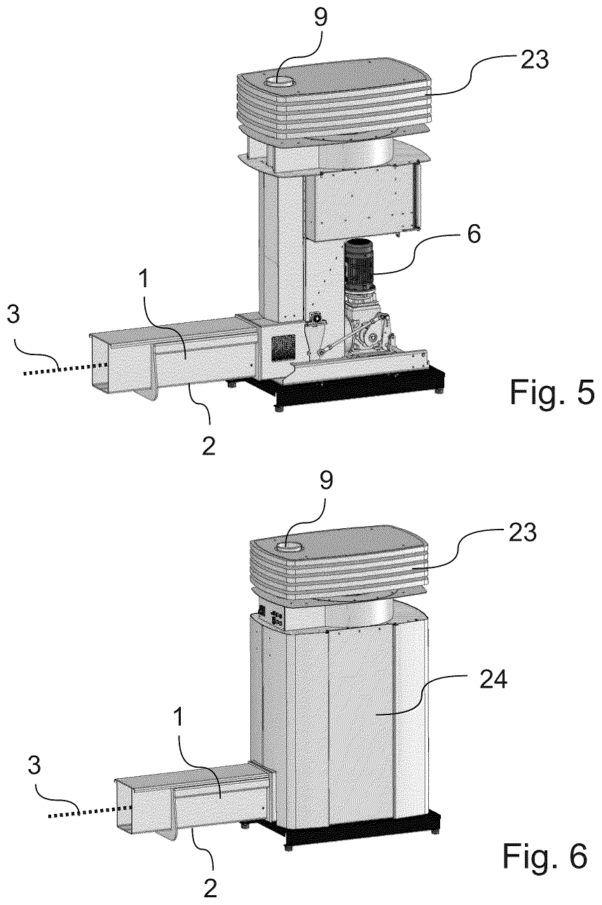

FIGS. 1 through 4 shows the working principle of the embodiment of a piston compactor according to the invention as shown in FIG. 5. The piston compactor comprises a compactor tube 1 with a tube wall 2 extending along a longitudinal axis 3 according to the general principle of such piston compactors a compactor piston 4 and a drive mechanism is arranged at one end of the compactor tube 1. According to this embodiment of the invention the drive mechanism comprises a carriage 5 with wheels arranged on a guide rail 7 allowing the carriage to move in a direction along the longitudinal axis 3. The carriage 5 also have an electric motor 6 that is connected via a crank mechanism so that when the motor 6 runs then this will force the compactor piston 6 to be repetitively moved along the longitudinal axis 3 between a retracted and an extended position in the compactor tube 1.

Thereby material, such as waste material, inserted into the compactor tube 1 via a feed opening 12 will be pressed out of the free end of the compactor tube by the compactor piston 6 when it moves from its retracted position shown in FIG. 4 and to the extended position shown in FIG. 1. In the free end of the compactor tube 1 a constriction 8 is arranged. It will be evident to the skilled person that such a constriction can be made in many different embodiments but in this embodiment the constriction 8 is a plate that is adjustably hinged at one side closest to the compactor piston 4 e.g. by means of an adjustable screw connection (not shown) so that it extends into the compactor tube 1 at an angle and thereby forming the constriction 8.

The piston compactor also have a feeding pipe 9 with pipe walls 10 and an outlet end 11 being connected to a feed opening 12 arranged in the wall 2 of the compactor tube 1 between the retracted and the extended position of the compactor piston 4. The feeding pipe 9 may be connected to a tubular pneumatic conveying system or any other source that can produce and transfer material to the feeding pipe 9 to be compacted by the piston compactor.

The piston compactor further comprises a first suction conduit 13 having a first end 14 that is connected to the feeding pipe 9 via a first suction opening 15 arranged near the feed opening 12 and a second end 17 that is connected to a suction source 16 e.g. a blower, and that a suction control 18 is adapted for applying suction to the feeding pipe 9 via the first end 14 of the first suction conduit 13 at least when the compactor piston 4 is in its extended position as shown in FIG. 1 and to shut off the suction at the first end 14 of the first suction conduit 13 at least when the compactor piston 4 is in its retracted position.

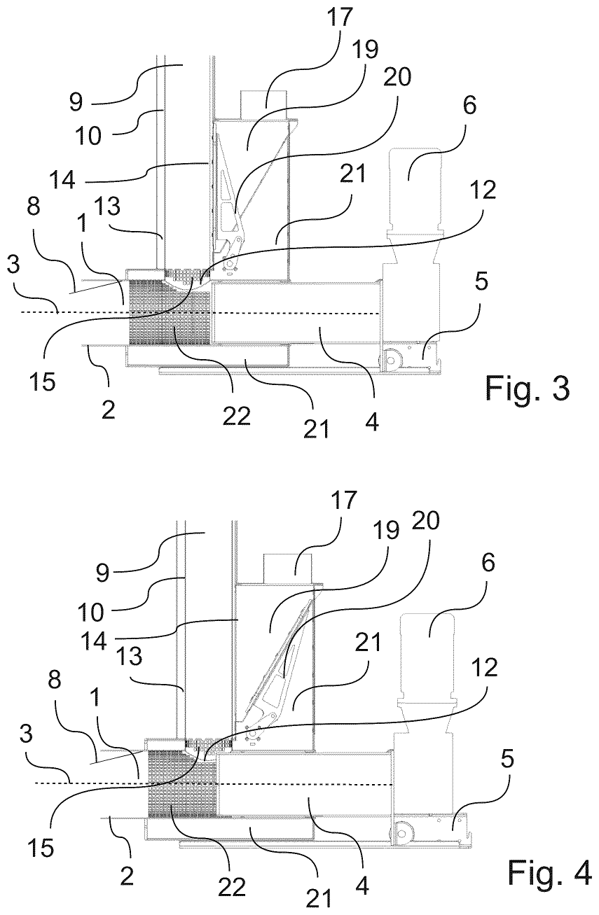

In this embodiment the control comprises Y-valve 19 with a hinged valve plate 20 that can be moved from the position as shown in FIGS. 1, 2 and 4 where it provides suction to the first suction conduit 13 and to the position shown in FIG. 3 where it closes the first suction conduit from the second end 17.

The first suction opening is here formed by a grid in the pipe wall 10 of the feeding pipe 9 so that material sucked into the feeding pipe 9 do not enter into the first suction conduit 13.

As shown in FIGS. 2, 3 and 4 the piston compactor further comprises a second suction conduit 21 having a first end connected to the tube wall of the compactor tube 1 and a second end that is connected to a suction source via the Y-valve 19, thereby the same suction source can provide suction to the compactor tube 1 when the suction control 18, formed by the Y-valve 19 with the hinged valve plate 20 is in the position as shown in FIG. 3 where the compactor piston is in its retracted position and to shut off the suction at the first end of the second suction conduit at least when the compactor piston is in its extended position as shown in FIGS. 1, 2 and 4.

The suction is applied to the compactor tube 1 via the second suction opening 22 being provided with a grid in order to prohibit material entering into the second suction conduit 21.

FIGS. 1 through 4 now illustrate a complete compaction cycle where:

FIG. 1 shows a first step where the compactor piston 4 is in its most extended position covering the feed opening 12 so that no material can enter from the feeding pipe 9 and into the compactor tube 1. Here the suction provided at the second end 17 is directed by the Y-valve 19 and into the feeding pipe 9 via the first suction conduit 13.

FIG. 2 shows a second step, where the compactor piston is moving from its extended position and in the direction towards its retracted position. Here the suction is still only provided to the feeding pipe 9 by the Y-valve 19.

FIG. 3 shows a third step where the compactor piston is in its retracted position. Here the valve plate 20 is moved so that the suction is closed to the first suction conduit 13 and thereby to the feeding pipe, and at the same time suction is now open to the second suction conduit 21 and thereby to the compactor tube 1 so that any material present in the feeding pipe 9 is now being sucked into the compactor pipe 1.

FIG. 4 shows a fourth step, where the compactor piston 4 is moved forward in the compactor tube 1 from it retracted position and to the extended position as shown in FIG. 1. Here the suction is closed from the compactor tube 1 by the Y-valve 19 and suction is again applied to the feeding pipe 9.

FIGS. 5 and 6 shows a piston compactor with all the components shown in FIG. 1 through 4. In this embodiment the piston compactor is a single unit that also comprises a blower 23 connected to the second end 17 shown in FIGS. 1 through 4. In FIG. 6 the whole unit is contained in a casing 24.

1. A piston compactor adapted for compacting waste material and comprising a compactor tube with a tube wall extending along a longitudinal axis and where a compactor piston and a drive mechanism is arranged at one end of the compactor tube and being adapted for repetitively moving the piston along the longitudinal axis between a retracted and an extended position in the compactor tube, and where the piston compactor comprises a feeding pipe with pipe walls and an outlet end being connected to a feed opening arranged in the tube wall between the retracted and the extended position, wherein the piston compactor further comprises a first suction conduit having a first end that is connected to the feeding pipe via a first suction opening arranged near the feed opening and a second end that is connected to a suction source, and a suction control that is adapted for applying suction to the feeding pipe via the first end of the first suction conduit at least when the compactor piston is in its extended position and to shut off the suction at the first end of the first suction conduit at least when the compactor piston is in its retracted position.

2. A piston compactor according to claim 1, wherein a grid is arranged in the first suction opening.

3. A piston compactor according to claim 1, further comprising a second suction conduit having a first end that is connected to the tube wall of the compactor tube and a second end that is connected to a suction source, and wherein the suction control is adapted for applying suction to the compactor tube via the first end of the second suction conduit at least when the compactor piston is in its retracted position and to shut off the suction at the first end of the second suction conduit at least when the compactor piston is in its extended position.

4. A piston compactor according to claim 3, wherein a grid is arranged in the second suction opening.

5. A piston compactor according to claim 3, wherein the suction source comprises a blower adapted to provide suction to the second end of both the first and the second suction conduit.

6. A piston compactor according to claim 5, wherein the blower is connected to the second end of both the first and the second suction conduit via a valve arrangement adapted for shifting the suction applied from the blower between the first and the second suction conduit.

7. A piston compactor according to claim 1 wherein the compactor comprises a single actuator or motor, and the single actuator or motor is configured to actuate both the valve arrangement and the compactor piston via a gear or a link mechanism.

8. A piston compactor according to claim 1 wherein the compactor tube has a second end and a constriction arranged between the second end and the compactor piston in its extended position.

9. A piston compactor according to claim 8, wherein the constriction comprises a control mechanism adapted for manual or automatic adjustment of the level of the size of the constriction.

10. A piston compactor according to claim 1 further comprising a housing containing the suction source, the compactor piston and its drive mechanism as well as the suction conduits, and wherein an outlet end of the compactor tube and an inlet end of the feed pipe opposite the outlet end both extend out of the housing.
